(19) United States
(12) Patent Application Publication
(10) Pub. No.: US 2006/0288370 A1
(43) Pub. Date: Dec. 21, 2006

(54) System and method for controlling a plurality of electronic devices

(76) Inventor: Leigh M. Rothschild, Plantation, FL (US)

Correspondence Address: CASELLA & HESPOS, 274 MADISON AVENUE, NEW YORK, NY, 10016, US

(21) Appl. No.: 11/125,929

(22) Filed: May 10, 2005

(51) Int. Cl. H04N 5/445

(52) U.S. Cl. 725/51

(57) ABSTRACT

A system and method for controlling an operation of at least one electronic device or appliance are provided. The system and method obviates the need of a user of a plurality of electronic devices, e.g., a television, digital video disc (DVD) player, VCR, etc, to keep track of and maintain a corresponding plurality of remote control devices. The system and method provide a user with a graphic representation of the remote control device for each electronic appliance on a display controllable by a single, easy-to-use, intuitive transmitter. The graphic representations and associated control codes for the plurality of electronic appliances are downloadable via a global computer network, e.g., the Internet. In accordance with the present disclosure, a user can access all of the functions of each of the plurality of electronic appliances with a single remote transmitter without having to manually program the transmitter for each electronic appliance.

### BACKGROUND

1. Field

The present disclosure relates generally to control systems for electronic devices or appliances, and more particularly, to systems and methods for remotely controlling a plurality of electronic devices through on-screen display graphic representations, communicating with a control device to program and setup these graphic representations through a global computer network, and interfacing with the control device though a small portable interface device.

2. Description of the Related Art

Various entertainment devices, e.g., televisions, digital video disc (DVD) players, VCRs, satellite receivers, etc., now litter the average home. These devices normally are operated through remote control (infrared or wireless) devices, with each entertainment device having its own remote control. Unified/universal remotes have attempted to end this ‘remote clutter’ but are limiting in design, functionality, and usefulness. Further, the unified/universal remotes are usually difficult to program and fail to have the look and feel of the original remote.

Therefore, a need exists for systems and methods for controlling a plurality of entertainment devices by a single, intuitive remote control device. Furthermore, a need exists for these systems and methods to function as an original remote control device without requiring programming of each device.

### SUMMARY

A system and method for controlling an operation of at least one electronic device or appliance are provided. The system and method of the present disclosure maintains the same look and feel and functionality of various original remotes supplied with entertainment devices, but renders them unnecessary. Further, the present disclosure details how entertainment devices may be controlled through one portable remote control transmitter that is very small and compact, or alternatively, controlled through one of the users pre-existing remotes. Moreover, this disclosure details how the remote transmitter communicates with an entertainment device (e.g. TV, Tivo™, stereo, DVD player, satellite receiver, cable control device, VCR, etc), thorough a control device that is either external or internally located in the entertainment device.

According to one aspect of the present disclosure, an apparatus for controlling an operation of at least one electronic device is provided. The apparatus includes a memory for storing a graphic of at least one remote control device and associated control codes for the at least one remote control device; a microprocessor for retrieving the graphic and outputting the graphic to a display; a receiver for receiving positional information for generating a pointer on the display relative to the graphic and for receiving a selection signal selecting a control function of the at least one remote control device, wherein the microprocessor retrieves a control code associated with the selected control function; and a transmitter for transmitting the control code to the at least one electronic device.

In another aspect of the present disclosure, a system for controlling an operation of at least one electronic device is provided. The system including a controller including a memory for storing a graphic of at least one remote control device and associated control codes for the at least one remote control device; a microprocessor for retrieving the graphic and outputting the graphic to a display; a first receiver for receiving positional information for generating a pointer on the display relative to the graphic and for receiving a selection signal selecting a control function of the at least one remote control device, wherein the microprocessor retrieves a control code associated with the selected control function; and a first transmitter for transmitting the control code to the at least one electronic device; and a remote transmitter comprising a position information input device for generating the positional information and at least one button for generating the selection signal.

In a further aspect of the present disclosure, a method for controlling an operation of at least one electronic device is provided. The method includes the steps of displaying a graphic of a remote control for the at least one electronic device on a display; generating a pointer on the display relative to the graphic, wherein the pointer selects a function on the graphic; retrieving a control code corresponding to the function; and transmitting the control code to the at least one electronic device.

### BRIEF DESCRIPTION OF THE DRAWINGS

The above and other aspects, features, and advantages of the present disclosure will become more apparent in light of the following detailed description when taken in conjunction with the accompanying drawings in which:

FIG. 1 is a diagram of a system for controlling at least one electronic device in accordance with an embodiment of the present disclosure;

FIG. 2 is a schematic diagram of a controller in accordance with an embodiment of the present disclosure;

FIG. 3 is a schematic diagram of a transmitter in accordance with an embodiment of the present disclosure;

FIG. 4 is a flowchart illustrating a method for programming the controller;

FIG. 5 is a flowchart illustrating a method for controlling an operation of at least one electronic device in accordance with the present disclosure; and

FIG. 6 illustrates several display views for describing various operations of the system of the present disclosure.

### DETAILED DESCRIPTION

Preferred embodiments of the present disclosure will be described hereinbelow with reference to the accompanying drawings. In the following description, well-known functions or constructions are not described in detail to avoid obscuring the present disclosure in unnecessary detail.

A system and method for controlling an operation of at least one electronic device or appliance is provided. The system and method of the present disclosure obviates the need of a user of a plurality of electronic devices, e.g., a television, digital video disc (DVD) player, VCR, etc, to keep track of and maintain a corresponding plurality of remote control devices. The system and method provide a user with a graphic representation of the remote control device for each electronic appliance on a display controllable by a single, easy-to-use, intuitive transmitter. The graphic representations and associated control codes for the plurality of electronic appliances are downloadable via a global computer network, e.g., the Internet. In accordance with the present disclosure, a user can access all of the functions of each of the plurality of electronic appliances with a single remote transmitter without having to manually program the transmitter for each electronic appliance.

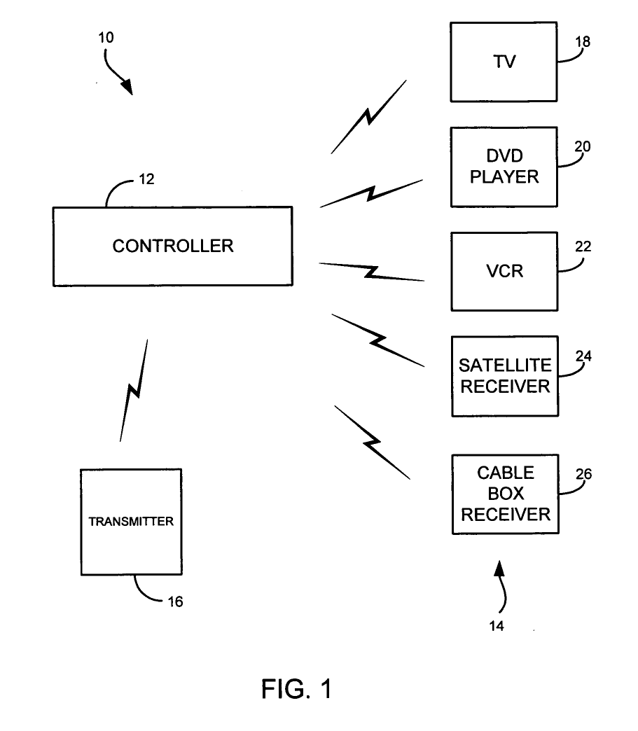

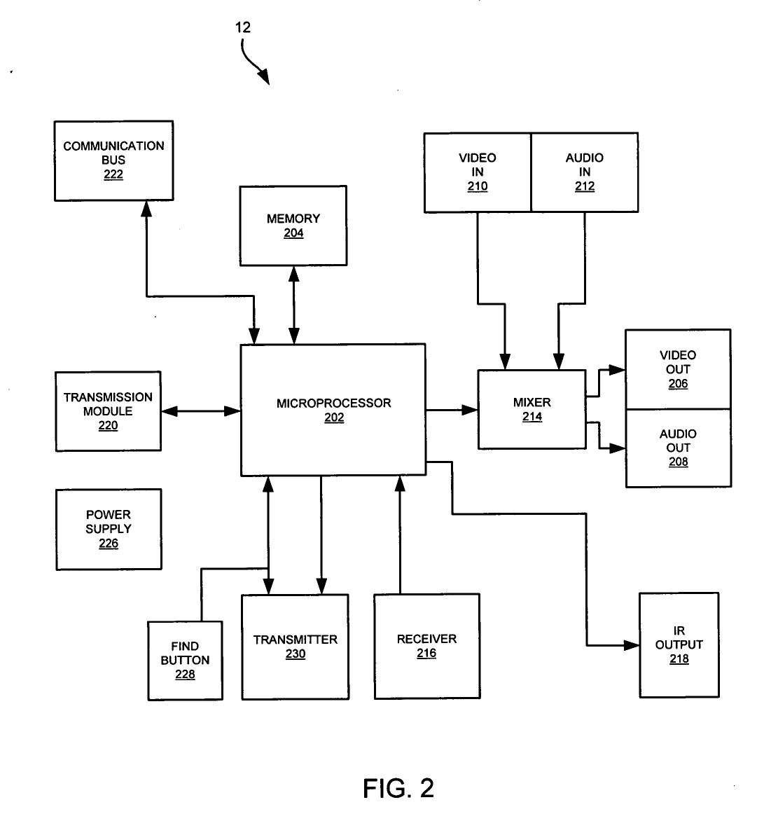

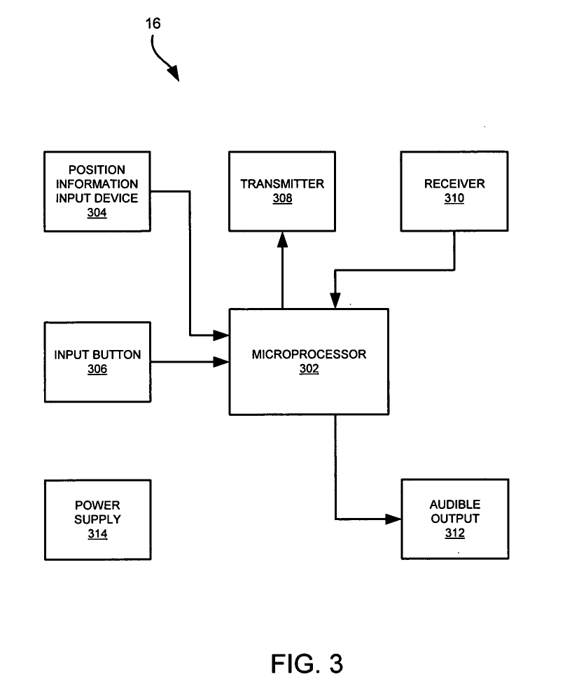

Referring to FIG. 1, a system for controlling an operation of at least one of a plurality of electronic devices or appliances is generally represented by the numeral 10. The system 10 includes a controller 12 for generating a graphic representation of at least one remote control device to be displayed on a display device, for receiving an input command relating to the at least one graphic and for generating and transmitting a control signal in response to the input command to at least one of a plurality of electronic devices 14. The electronic devices may include any known electronic appliance or component commonly employed in a home entertainment system, e.g., a television 18, a digital video disc (DVD) player 20, a VCR 22, a satellite receiver 24, a cable box receiver 26, etc. The electronic devices may further include lighting systems and computer systems. The system 10 further includes a remote control transmitter 16 for generating and transmitting command signals to the controller 12. Both the controller 12 and transmitter 16 will be described in more detail below with reference to FIGS. 2 and 3.

The controller 12 includes a microprocessor 202 for controlling the overall operations of the controller 12. A memory 204 is coupled to the microprocessor 202 and stores a plurality of graphic representations and command codes associated with a particular electronic appliance. The graphic representation is an image of the remote control device associated with a particular electronic appliance. The command codes that would normally emanate from the remote control are stored along with the graphic and will be employed to control the electronic appliance as will be described in more detail below.

A video output port 206 for outputting a video signal to a display, e.g., a television, CRT monitor, etc., and an audio output port 208 for outputting an audio signal are provided. The video output port 206 may be any known output interface including but not limited to a composite output, S-video, video graphics array (VGA), digital video interface (DVI), etc. The video output port 206 is coupled to the microprocessor 202 and receives the graphic of the remote control device and transmits the graphic to a display device. The controller 12 further includes a video input 210 and audio input 212 that are coupled to the video output port 206 and audio output port 208 via a mixer 214. In one state, the mixer 214 will receive signals from the video input 210 and audio input 212 and pass them straight through to the video output port 206 and audio output port 208. Here, the video input 210 and audio input 212 are basically pass-through jacks that mirror the original jacks, or ports, on the display device to allow a user to utilize the input jacks or ports of the display device even when the controller 12 is connected thereto. In another state, the mixer 214 will superimpose a graphic of a remote control device onto the video signal received from the video input 210. The superimposed graphic may consume the whole screen of the display device or may act as a pop-up on a small portion of the viewable area of the display.

A receiver 216 is provided for receiving positional information from the transmitter 16 and transmitting the positional information to the microprocessor 202. Once the graphic is displayed on the display, the transmitter 16 will act as a cursor control device to align a pointer over a specific function button on the remote control graphic. The receiver 216 will determine the cursor position information and send it to the microprocessor 202 which will generate a pointer in the relative position on the graphic. The receiver 216 may be a photosensor for receiving infrared signals or may be a conventional receiver operating under any of the various known wireless protocols including but not limited to Bluetooth™ interconnectivity, radio transmission connectivity including computer digital signal broadcasting and reception commonly referred to as Wi-Fi or 802.11x (where x denotes the type of transmission), or any other type of communication protocol or system currently existing or to be developed for wirelessly transmitting data.

Once a control function has been determined by the microprocessor 202 by determining the pointer location on the remote control graphic, the microprocessor will retrieve the proper control code from the memory 204 and transmit the control code to the appropriate electronic device via an infrared (IR) blaster 218, as is known in the art. An exemplary IR blaster is model IR-200L commercially available from ACTiSYS Corp. of Fremont, Calif. The infrared blaster 218 will transmit the control code via a series of infrared light pulses as would the original remote control device associated with the particular electronic appliance. The IR blaster 218 preferably is integral within a housing of the controller 12 but may located remotely from the controller to be in close proximity to the IR receiver of the particular electronic appliance.

The controller 12 further includes a transmission module 220 for coupling the controller 12 to a global computer network, e.g., the Internet, to enable data transmission between the controller 12 and other computing devices, e.g., a web server. The transmission module 220 may be but not limited to a network interface card (NIC), e.g., an Ethernet card, a WI-FI card, a Bluetooth™ transceiver, an analog/digital modem or any other known data transmission device. As will be described in more detail below, the controller 12 will access a web server during initial setup and programming and to retrieve further graphics and codes as new remote control devices are added to the system. A user will go to an established website on the Internet to register the controller 12 and existing remote control device models. A download then occurs to the controller 12 of images and bitmap charts of the remote controls selected and also the code sets for the remote control devices to be utilized with the IR blaster 218. By example if a Phillips™ remote for a VCR is registered, an image of that remote and bit map/programming would be downloaded and stored in memory in the controller 12. The controller 12 would then interpret when the transmitter 16 aligns points on the image of the remote, and subsequently, specific IR signals would be emitted from the IR blaster 218 to control the Phillips™ VCR.

The controller also includes a communication bus module 222 for coupling a plurality of controllers 12 together via a daisy-chained hardwire connection. By locating several controllers throughout a location, e.g., a home, the controllers can be located near electronic appliances located in various locations allowing a user to have control over the various electronic appliances from any controller location. The communication bus module 222 may additionally couple a plurality of infrared repeaters to the controller 12 for controlling electronic devices located remotely from the controller 12.

Optionally, the controller 12 may include a find button 228, e.g., a momentary switch, which when depressed will initiate a locate signal to the remote control transmitter 16. The find button 228 may be directly coupled to a transmitter 230 or to the transmitter 230 via the microprocessor 202. The operation of the find button and locate signal will be described in more detail below in relation to the remote control transmitter 16.

A power supply 226 is coupled to at least the above-mentioned components for supplying power to each component. Preferably, the power supply 226 is externally powered by AC current. The power supply 226 preferably also includes a battery back-up for retaining the contents of memory 204 in the event of a power supply failure.

It is to be understood that the present disclosure may be implemented in various forms of hardware, software, firmware, special purpose processors, or a combination thereof. A system bus couples the various components shown in FIG. 2 and may be any of several types of bus structures including a memory bus or memory controller, a peripheral bus, and a local bus using any of a variety of bus architectures. The system also includes an operating system and micro instruction code. The various processes and functions described herein may either be part of the micro instruction code or part of an application program (or a combination thereof) which is executed via the operating system.

It is to be further understood that because some of the constituent system components and method steps depicted in the accompanying figures may be implemented in software, the actual connections between the system components (or the process steps) may differ depending upon the manner in which the present disclosure is programmed. Given the teachings of the present disclosure provided herein, one of ordinary skill in the related art will be able to contemplate these and similar implementations or configurations of the present disclosure.

In a preferred embodiment of the present disclosure, the controller or controller components would be hardwired and resident in either a television, or another ancillary device hooked to a television or entertainment device such as a cable television control device, satellite television control device, Tivo™ or other type of personal (digital) recording device, DVD player, VCR, personal media computer, or any other type of device that is coupled to a display monitor.

Referring to FIG. 3, the remote control transmitter 16 of the present disclosure is illustrated. The transmitter 16 includes a microprocessor 302 for controlling the overall operations of the transmitter 16, receiving input information and generating command signals to be transmitted to the controller 12. The transmitter 16 includes a positional information input device 304, e.g., a touch pad, for generating a relative position information signal which will be transmitted to the controller 12. The positional information input device 304 will control the pointer or cursor on the display for selecting a function on the graphic of the selected remote control device. The transmitter 16 also includes at least one button 306 for confirming selection of a control function on the graphic of the remote control.

The microprocessor 302 will receive the input signals generated by positional information input device 304 and the at least one button 306 and will generating a command signal that will be transmitted to the controller 12 by transmitter 308. The transmitter 308 will operate under a compatible protocol with the receiver 216 of the controller 12.

The transmitter 16 will further include a receiver 310 for receiving data from the controller 12. Preferably, the receiver 310 will receive a locate signal from the controller 12 and transmit the received locate signal to the microprocessor 302 which will in turn generate a signal to activate an audible output 312, e.g., a speaker, buzzer, tone generator, etc. In this manner, upon depressing the find button 228 on the controller 12, the transmitter 16 will produce an audible sound facilitating a user locating the transmitter 16.

Furthermore, a power supply 314 is coupled to at least the above-mentioned components for supplying power to each component of the remote controller transmitter 16.

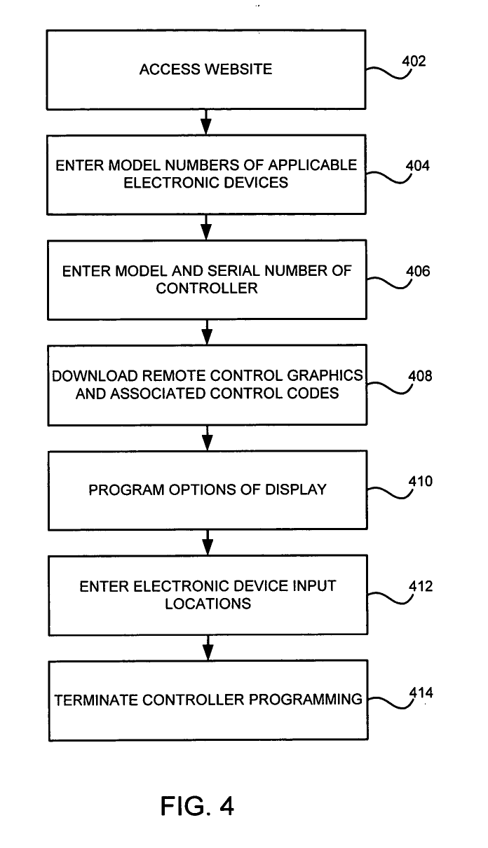

A method for programming the controller 12 will now be described with reference to FIG. 4. Initially, in step 402, a user goes to a designated website. The user will be prompted to enter the model numbers of their applicable devices, e.g., television, DVD player, etc. in registration form (step 404). Then, in step 406, the user will be prompted to enter the model and serial number of controller 12 in their possession and to indicate a network connection of the controller 12 (and type of connection, e.g. Bluetooth™, wired, WiFi, etc). A web server then contacts the controller 12 through a local network connection and sets up the controller 12, where the microprocessor 202 is programmed with executable instructions, and software is now resident to display various remote control graphics (step 408). The control codes associated with each electronic device and/or remote control is also downloaded and stored in memory 204.

Optionally, the user may also designate any existing remote control as the remote to replace the transmitter 16 by entering at the website the model number and manufacturer of the existing remote control, and the controller 12 will then accept IR input from the designated remote control device.

In step 410, the user then tells controller 12 during setup, either through the global computer network or alternatively at the controller 12 itself, how the remote control graphic is to be displayed during use. For example, the user will select a color of TV background, whether the graphic is a full overlay or see through overlay, a position for the pop-up graphic to appear, and size of pop-up, time for overlay to appear, tactile information (such as occurs during computer mouse setup), order for remotes to be displayed in, whether graphic remotes appear, or just keyboard remote choices. Following this step, the user may check to see if all remote controls are displayed on the screen.

Next, in step 412, the user also tells the controller 12 where each electronic device or appliance is located on the display/TV inputs, e.g. DVD is video input number one, VCR is video input 2, high def sat is dvi-1, cable is ant A, Tivo™ is input-2, etc. At this point, the controller 12 is programmed and the setup procedure is terminated (step 414). The user may now employ the single transmitter 16 to control the plurality of electronic devices.

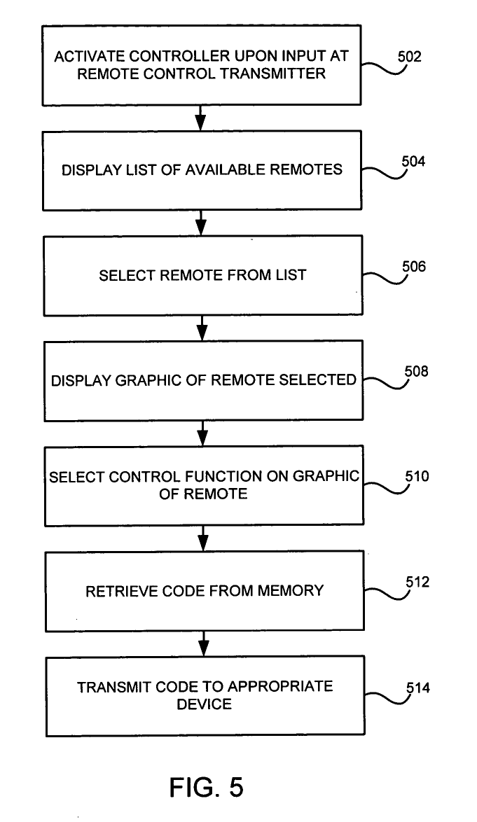

Referring to FIG. 5, a method for controlling an operation of at least one electronic device in accordance with the present disclosure is illustrated. Initially, in step 502, the user will activate the controller 12 upon any input at the remote control transmitter 16, e.g., clicking one of the buttons 306 or touching the touch pad 304. Once the user activates the controller 12, a pop up will appear, either replacing an image on the display or overlaying the image on the display, listing the remotes and/or electronic devices that have been programmed into the system (step 504). In step 506, the user can scroll down with the position information input device 304 on the remote transmitter 16 to pick the remote or device they want. Next, a remote graphic or picture of the remote selected appears (step 508).

Once the graphic of the remote is displayed, the user can then operate the selected remote through the transmitter 16 with scroll controls and button controls (step 510). Using the touch pad, the user aligns a pointer or cursor on a control button of the displayed graphic, e.g., a play button, and selects the functions with a click of the at least one button 306. The controller 12 correlates the position that the user has selected on the remote graphic, and using standard programming instructions and processing power of the microprocessor 202, the controller 12 retrieves the appropriate control code from memory 204 (step 512). Then, the controller 12 orders the IR instruction code for the position selected on the remote control to be emitted (blasted) from the IR blaster 218 to the entertainment devices. Entertainment devices are thus controlled with a single small remote transmitter 12 (or the users existing remote if selected) and all remote control images can be resident on screen whenever they are needed. The remote transmitter can control any function available on the selected remote, e.g., change a channel, adjust volume, play a DVD, fast forward a video tape, etc.

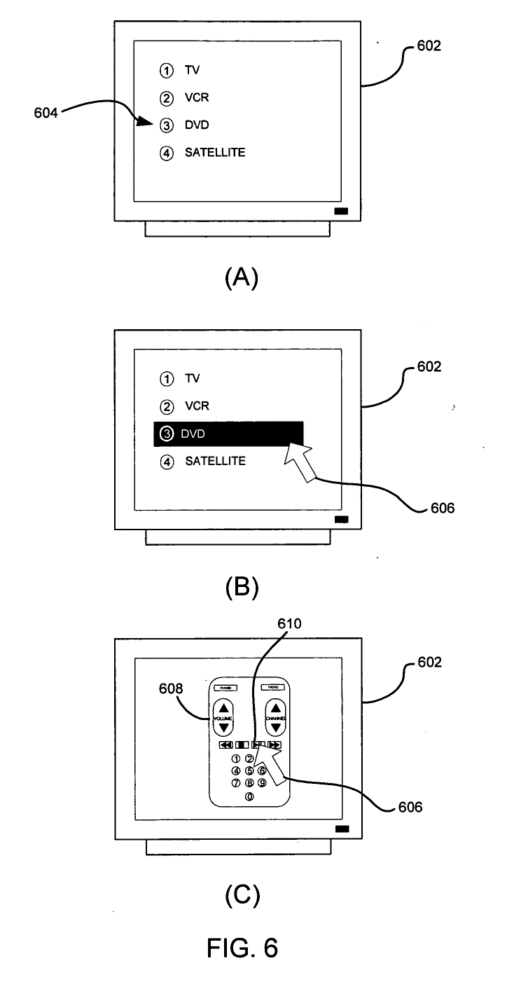

To further illustrate the operations of the system 10 of the present disclosure, FIG. 6 shows several display views generated by the system 10. Initially, the user signals the controller 12 to display a list 604 of remotes on a display 602, e.g., a television (see FIG. 6A). Using the touch pad on the transmitter, the user moves the pointer 606 to select the DVD player (see FIG. 6B). Then, the DVD player remote appears and, at the same time, the controller 12 transits a signal via the IR blaster 218 to switch TV input to the input that the DVD player is located on, which it knows from user setup described above. The graphic 608 of the selected remote remains overlaid on the screen of the display 602 as shown in FIG. 6A. The user may then select “DVD play” on the remote graphic 608 by scrolling and then clicking on the play button 610. The controller then blasts the DVD player to start a play sequence. The user may then watch the movie and remote overlay disappears after a predetermined, user adjustable time. At a later time, the user may click the transmitter 16 and the last graphic (e.g., DVD remote) appears. The user may then scroll to and then click the pause button and the controller 12 blasts the player DVD to pause. The user may then click another button of the at least one button 306 and the list of all remotes in the system appears (FIG. 6A). The user aligns and clicks TV, and a graphic of the TV's remote pops up on screen. The user clicks the power button on graphic of the TV remote and the TV shuts down.

In another embodiment of the present disclosure, a user can network at least one other controller 12, which is Ethernet/Bluetooth/Wi-Fi connected, to a remote display/television location. The output of the display/television would be connected to the input on the controller. The user may then from a main location also control remotely located devices such as a Tivo™ control device, etc., providing said devices have a video output. This video output would be streamed from the remote location controller to the main controller on the local computer network (either WiFi or Ethernet wiring, or Bluetooth, etc.) and the user would then see this streamed content output from the main controller video output signal which is input to the local display device.

In a further embodiment, the controller is resident in an entertainment device and, using a local or global computer network, communicates (via Wi-Fi/Bluetooth, etc. or wired) the status of the device to a user. The status information includes but is not limited to: power on/power off, audio volume, channel indication, signal frequency indication, internal temperature, power consumption, storage space, e.g., memory, for a resident digital storage device both free and utilized, sharpness of image, brightness of image, color of image, convergence aspects of display tube, etc. This information may be viewable by the user at a website or may be e-mailed to the user. Alternatively, a manufacturer of the entertainment device may receive the information and contact the user if they detect a possible malfunction with the device.

A system and method for controlling an operation of at least one electronic device, e.g., an entertainment device, has been described. The system and method of the present disclosure eliminates the need for a multitude of remote controls, simplifies the programming of a plurality of remotes into a single device, e.g., transmitter 16, is totally scalable and upgradeable, and the remote control transmitter 16 has a very small form factor.

While the disclosure has been shown and described with reference to certain preferred embodiments thereof, it will be understood by those skilled in the art that various changes in form and detail may be made therein without departing from the spirit and scope of the disclosure as defined by the appended claims.

What is claimed is:

1. An apparatus for controlling an operation of at least one electronic device, the apparatus comprising:
a memory for storing a graphic of at least one remote control device and associated control codes for the at least one remote control device;
a microprocessor for retrieving the graphic and outputting the graphic to a display;
a receiver for receiving positional information for generating a pointer on the display relative to the graphic and for receiving a selection signal selecting a control function of the at least one remote control device, wherein the microprocessor retrieves a control code associated with the selected control function; and
a transmitter for transmitting the control code to the at least one electronic device.

2. The apparatus of claim 1, further comprising a transmission module for coupling the apparatus to a computing network for downloading a plurality of graphics and associated control codes.

3. The apparatus of claim 1, wherein the transmitter is an infrared blaster.

4. The apparatus of claim 1, wherein the receiver receives data by a wireless protocol.

5. The apparatus of claim 1, further comprising a communication bus module for coupling at least one additional apparatus for controlling at least one second electronic device located remotely.

6. The apparatus of claim 1, further comprising a communication bus module for coupling at least one infrared repeater to the apparatus for transmitting the control code to at least one second electronic device located remotely.

7. The apparatus of claim 1, further comprising a video input port for receiving a video signal to be displayed on the display and a mixer coupled to the video input port and microprocessor for superimposing the graphic on the video signal.

8. The apparatus of claim 7, wherein the graphic appears on the display as a full overlay, see-through overlay or a pop-up.

9. The apparatus of claim 1, wherein the apparatus is disposed within the at least one electronic device.

10. The apparatus of claim 9, further comprising a transmission module for coupling the apparatus to a computing network and for transmitting status of the at least one electronic device to a remote computer.

11. The apparatus of claim 10, wherein the status includes at least one of power on/power off, audio volume, channel indication, signal frequency indication, internal temperature, power consumption, storage space both free and utilized, sharpness of image, brightness of image, color of image and convergence aspects of display tube.

12. The apparatus of claim 1, wherein the positional information and the selection signal are generated by a wireless remote transmitter.

13. The apparatus of claim 12, wherein the wireless remote transmitter is an original remote control device associated with the at least one electronic device.

14. A system for controlling an operation of at least one electronic device, the system comprising:
a controller comprising:
a memory for storing a graphic of at least one remote control device and associated control codes for the at least one remote control device;
a microprocessor for retrieving the graphic and outputting the graphic to a display;
a first receiver for receiving positional information for generating a pointer on the display relative to the graphic and for receiving a selection signal selecting a control function of the at least one remote control device, wherein the microprocessor retrieves a control code associated with the selected control function; and
a first transmitter for transmitting the control code to the at least one electronic device; and
a remote transmitter comprising a position information input device for generating the positional information and at least one button for generating the selection signal.

15. The system of claim 14, wherein the position information input device is a touch pad.

16. The system of claim 14, wherein the remote transmitter further includes a second receiver for receiving a find signal from the controller and an audible output for producing an audible sound in response to the find signal.

17. The system of claim 14, further comprising a transmission module for coupling the controller to a computing network for downloading a plurality of graphics and associated control codes.

18. The system of claim 14, wherein the first transmitter is an infrared blaster.

19. The system of claim 14, wherein the first receiver receives data by a wireless protocol.

20. The system of claim 14, wherein the controller further comprises a communication bus module for coupling at least one additional controller for controlling at least one second electronic device located remotely.

21. The system of claim 14, wherein the controller further comprises a communication bus module for coupling at least one infrared repeater to the controller for transmitting the control code to at least one second electronic device located remotely.

22. The system of claim 14, wherein the controller further comprises a video input port for receiving a video signal to be displayed on the display and a mixer coupled to the video input port and microprocessor for superimposing the graphic on the video signal.

23. The system of claim 22, wherein the graphic appears on the display as a full overlay, see-through overlay or a pop-up.

24. The system of claim 14, wherein the controller is disposed within the at least one electronic device.

25. The system of claim 24, further comprising a transmission module for coupling the apparatus to a computing network and for transmitting status of the at least one electronic device to a remote computer.

26. The system of claim 25, wherein the status includes at least one of power on/power off, audio volume, channel indication, signal frequency indication, internal temperature, power consumption, storage space both free and utilized, sharpness of image, brightness of image, color of image and convergence aspects of display tube.

27. The system of claim 14, wherein the remote transmitter is an original remote control device associated with the at least one electronic device.

28. A method for controlling an operation of at least one electronic device, the method comprising the steps of:
displaying a graphic of a remote control for the at least one electronic device on a display;
generating a pointer on the display relative to the graphic, wherein the pointer selects a function on the graphic;
retrieving a control code corresponding to the function; and
transmitting the control code to the at least one electronic device.

29. The method of claim 28, wherein the displaying step further comprises the steps of generating a list of a plurality of electronic devices and selecting the at least one electronic device from the list.

30. The method of claim 28, wherein the display includes a plurality of input ports each coupled to one of the plurality of electronic device, further comprising the step of switching the display to the input port coupled to the selected electronic device.

31. The method of claim 28, further comprising the step of retrieving at least one additional graphic and associated control codes from a server via a network.

32. The method of claim 28, further comprising the step of selecting at least one characteristic of the display.

33. The method of claim 32, wherein the at least one characteristic of the display is at least one of a color of the display background; whether the graphic is a full overlay, see-through overlay or a pop-up; a position for the pop-up graphic to appear and size of the pop-up graphic; time for overlay or pp-up to appear; tactile information; order for remotes to be displayed in; and whether graphic remotes appear or other user selected preferences.
